(19) United States
(12) Patent Application Publication
(10) Pub. No.: US 2015/0077629 A1
(43) Pub. Date: Mar. 19, 2015

(54) CAMERA MODULE

(71) Applicant: LG INNOTEK CO., LTD., Seoul (KR)

(72) Inventor: Youn Baek JEONG, Seoul (KR)

(73) Assignee: LG Innotek Co., Ltd.

(21) Appl. No.: 14/485,058

(22) Filed: Sep. 12, 2014

(30) Foreign Application Priority Data
Sep. 13, 2013 (KR) 10-2013-0110221

(51) Int. Cl. H04N 5/225

(52) U.S. Cl. CPC H04N 5/2254
USPC 348/374

(57) ABSTRACT

A camera module includes a rectangular image sensor including an effective image area, and a rectangular PCB mounted with the image sensor. The effective image area comprises a first side and a second side formed longer than the first side. The first side is parallel with a long side of the PCB, and the second side is parallel with a short side of the PCB.

### CROSS-REFERENCE TO RELATED APPLICATION

This application claims priority under 35 U.S.C. §119 to Korean Application No. 10-2013-0110221 filed on Sep. 13, 2013, whose entire disclosure is hereby incorporated by reference.

### BACKGROUND

1. Field

The teachings in accordance with exemplary and non-limiting embodiments of this disclosure generally relate to a camera module, and more particularly to a small-sized camera module configured to be used for mobile devices.

2. Background

As miniaturization of camera modules is enabled, camera modules come to be mountable with various electronic devices including mobile terminals. Concomitant with improved communication environment and generalized distribution of various mobile terminals capable of video calls, demands on development of a front camera module having a high-pixel image sensor capable of performing a high definition video call are required.

Generally, a front camera module is arranged at a bezel area of a mobile terminal. However, a front camera module having a high-pixel image sensor is larger than a conventional front camera module having a low-pixel image sensor. Thus, when a front camera module having a high-pixel image sensor is mounted on a mobile terminal to implement a high definition video call, a bezel on a mobile terminal is thickened thickness-wise, and it is difficult to miniaturize the mobile terminal and to reduce the size of the bezel.

Furthermore, a conventional front camera module has an effective image area of 4:3 ratio that is not supported by a high definition picture quality, and the effective image area is disadvantageously mounted regardless of direction of display panel, which is resultant from a structure where a vertical length of a display panel on a conventional mobile terminal is longer than a horizontal length. Thus, video call images are displayed with vertically-cut images when the conventional structure is applied as is to recent mobile terminals such as smart phones, and a screen quality is degraded when a screen is outputted using an entire space of the display panel.

### BRIEF DESCRIPTION OF THE DRAWINGS

The embodiments will be described in detail with reference to the following drawings in which like reference numerals refer to like elements wherein:

FIG. 1 is a cross-sectional view illustrating a PCB of a camera module according to a first exemplary embodiment of the present disclosure;

FIG. 2 is a cross-sectional view taken along line II-II of FIG. 1;

FIG. 3 is a cross-sectional view taken along line III-III of FIG. 1;

FIG. 4 is a cross-sectional view illustrating a PCB of a camera module according to a second exemplary embodiment of the present disclosure;

FIG. 5 is a cross-sectional view taken along line V-V of FIG. 4; and

FIG. 6 is a schematic view illustrating an arrangement relationship when a camera module according to the exemplary embodiment of the present disclosure is mounted on a mobile terminal.

### DETAILED DESCRIPTION

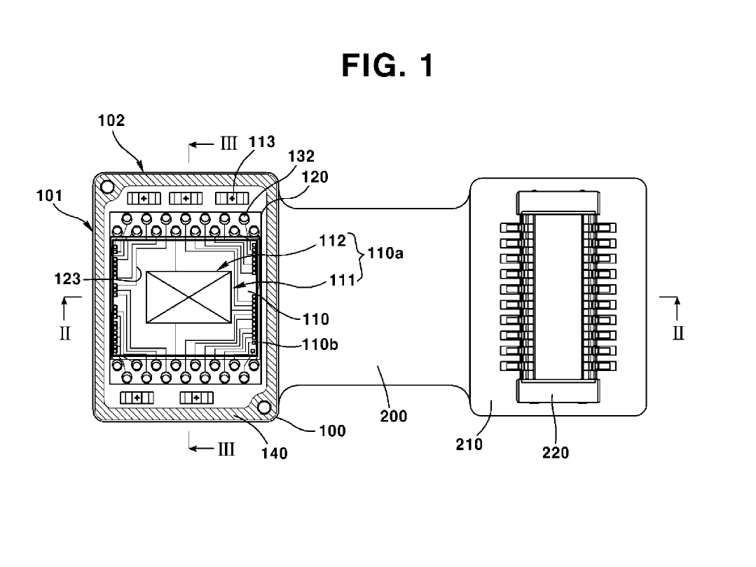

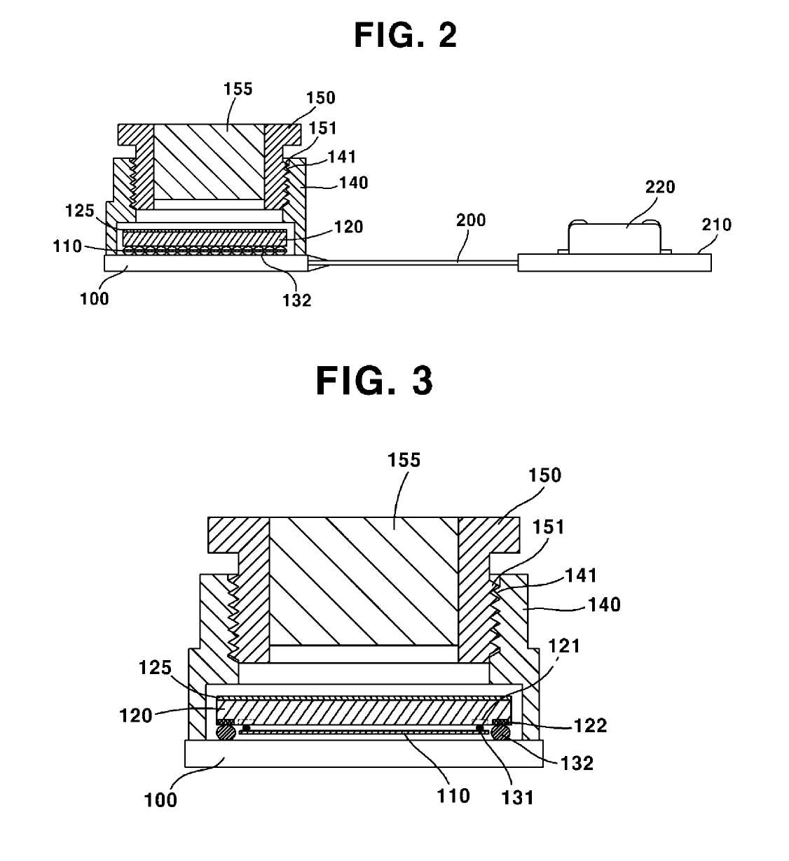

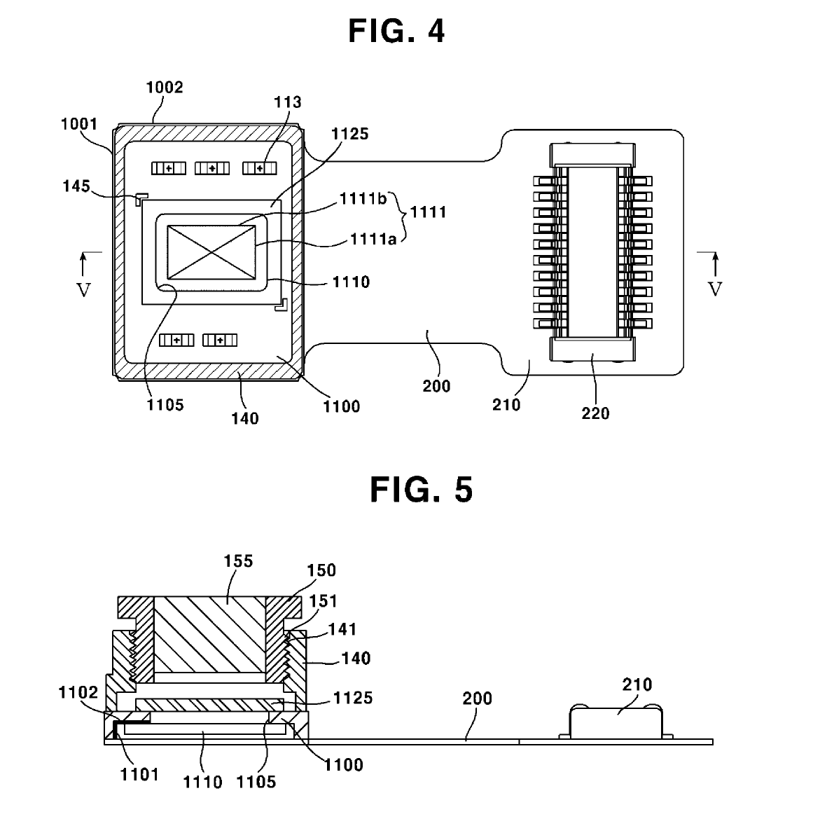

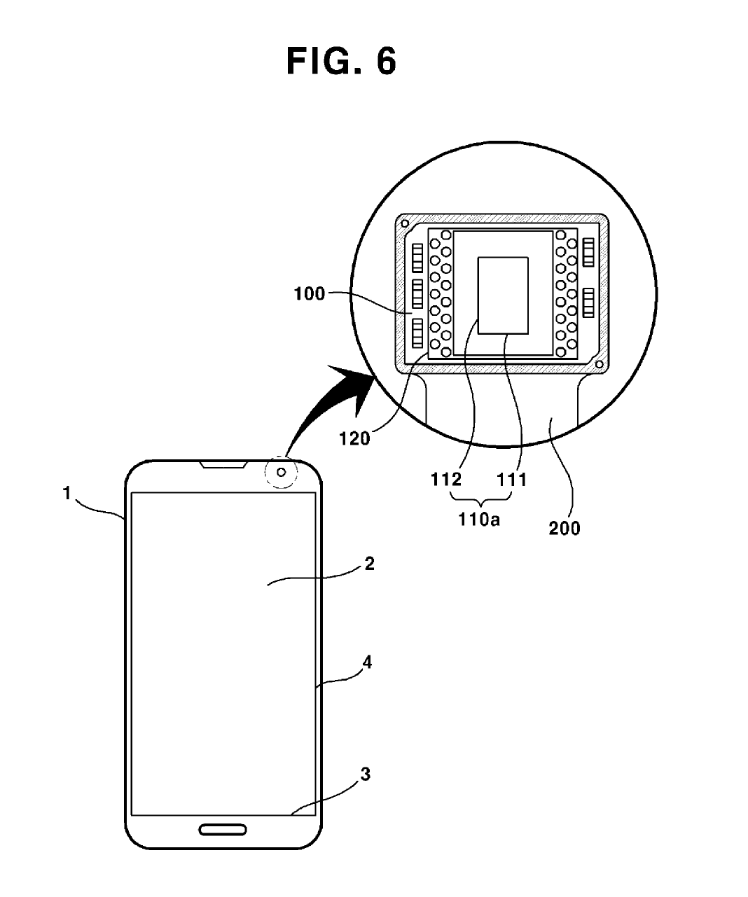

FIG. 1 is a cross-sectional view illustrating a PCB of a camera module according to a first exemplary embodiment of the present disclosure, FIG. 2 is a cross-sectional view taken along line II-II of FIG. 1, FIG. 3 is a cross-sectional view taken along line III-III of FIG. 1, FIG. 4 is a cross-sectional view illustrating a PCB of a camera module according to a second exemplary embodiment of the present disclosure, FIG. 5 is a cross-sectional view taken along line V-V of FIG. 4, and FIG. 6 is a schematic view illustrating an arrangement relationship when a camera module according to the exemplary embodiment of the present disclosure is mounted on a mobile terminal.

Referring to FIGS. 1 to 3, a camera module according to a first exemplary embodiment of the present disclosure may include a PCB (100) and an image sensor (110). The PCB (100) may be mounted with the image sensor (110) using a CSP (Chip Scale Package) process. Furthermore, the PCB (100) may be mounted with a component part (113). The component part (113) may be a controller configured to perform an image data process of the image sensor (110), or active and passive elements for noise removal.

The PCB (100) may be connected to a connector (210) having a terminal socket (220) via a cable (200) in order to be connected to outside devices such as a mobile terminal (see FIG. 6) mounted with a camera module as illustrated in FIGS. 1 to 4. The shapes and types of the connector (210) and the socket (220) may be variably configured.

A semiconductor device used for the image sensor (110), which is a CCD (Charged Coupled Device) or a CMOS (Complementary Metal-Oxide Semiconductor) image sensor, is a semiconductor device configured to take an image of a man or an object using an optical transducer and a charge coupled device and to output an electric signal. The semiconductor device used for the image sensor (110) has various applicable fields such as industrial purpose and military purpose, and recently starts to be mounted on a mobile terminal (1, see FIG. 6) such as a digital camera or a smart phone, and its demand has greatly increased.

The image sensor (110) includes an effective image area (110a) and a plurality of terminal parts (110b) as illustrated in FIG. 1. The effective image area (110a) is provided in a rectangular form as illustrated in FIG. 1. The effective image area (110a) is formed by a first side (111) and a second side (112), where the second side (112) is longer than the first side (111). Although a length ratio of the first and second sides (111, 112) may be variably configured, a length ratio of the first and second sides (111, 112) may be 16:9 in order to support a full high definition image, for example, but the present disclosure is not limited thereto.

The first side (111) may be parallel with a long side (101) of the PCB (100) and the second side (112) may be parallel with a short side of the PCB (100). Furthermore, the camera module according to the first exemplary embodiment of the present disclosure may be mounted on the mobile terminal (1) as illustrated in FIG. 6. The mobile terminal (1) includes a display panel (2) where the display panel (2) may have a third side (3) and a fourth side (4) that is longer that the third side (3). The camera module according to the first exemplary embodiment of the present disclosure may be mounted on the mobile terminal (1), where the first side (111) is parallel with the third side (3) and the second side (2) is parallel with the fourth side (4).

The terminal part (110b) is formed outside of the effective image area (110a). The terminal part (110b) may include a plurality of pads or contacts and is provided to apply a control signal to the image sensor (110) or to supply a power to the image sensor (110). The plurality of terminal parts (110b) may be connected in a wiring pattern. The terminal parts may be conductively connected to a glass substrate (120) as illustrated in FIG. 3. The connected structure of the terminal parts (110b) will be described hereinafter.

The terminal part (110b) may be arranged outside of the first side (111) as illustrated in FIG. 1. An outside of the second side (112) is not formed with the terminal part (110b). The first side (111) is installed parallel with the long side of the PCB (100) such that the terminal part (110b) may be arranged near to the long side (101) of the PCB (100).

The exemplary embodiments of the present disclosure will be described in detail as under where an effective image area of an image sensor is arranged to a direction same as that of a display panel of a mobile terminal, and a length of a side of a PCB corresponding to a lower side of the image sensor can be reduced.

The image sensor (110) of the camera module according to the first exemplary embodiment of the present disclosure may be mounted on the PCB (100) using a CSP process as illustrated in FIGS. 1 to 3. The CSP process relates to a package less than 1.2 times the chip size or a pitch of a solder ball is 0.8 mm, and the image sensor (110) may be modularized in a package shape by a glass substrate (120), a wiring pattern (123) of metal material formed on the glass substrate (120) and a passivation layer (not shown) configured to protect the wiring pattern (123). That is, the glass substrate (120) may be arranged at an upper surface of the image sensor (110).

The glass substrate (120) is conductively connected at a first terminal (121) to the image sensor (110), and conductively connected at a second terminal (122) to the PCB (110). The first and second terminals (121, 122) may be connected to the wiring pattern (123). The PCB (100) may be an R-FPCB (Rigid-Flexible Printed Circuit Board), a conventional PCB, or a ceramic substrate.

The first terminal (121) may be conductively connected to the image sensor (110) and the PCB (100) via a first member (131), and the second terminal (122) may be conductively connected to the image sensor (110) and the PCB (100) via a second member (132). The first and second members (131, 132) may be formed with a conductive material, and may be formed with various materials such as solder and gold bump.

The second member (132) may be formed by any one of a solder ball and a gold bead arranged at a space between the second side (112) and the short side (102) of the PCB (100). As illustrated in FIG. 1, the second member (132) conductively connects the glass substrate (120) to the PCB (100). The second member (132) may be arranged at a space between an outside of the second side (112) and the short side (102) of the PCB (100).

The terminal part (110b) and the second member (132) are connected by the wiring pattern (123), such that the long side (101) of the PCB (100) near to the terminal part (110b) needs no structure for connecting the second member (132) to the PCB (100) through the solder ball or the wire bonding work. The first side (111) of the effective image area (110a) and the long side (101) of the PCB (100) can be closely arranged to enable minimization of size of the PCB (100).

The glass member (120) may be formed at a surface with an IR (Infrared) cut-off layer (125). The present disclosure is not limited thereto though, and the IR cut-off layer may be formed on a floor surface or in the middle of the glass member (120). The IR cut-off layer (125) may be formed by attaching a film or by coating. The IR cut-off layer (125) may be formed by an anti-glare coating.

Referring to FIGS. 4 and 5, a camera module according to a second exemplary embodiment of the present disclosure may include a PCB (1100) and an image sensor (1110). The PCB (1100) may be mounted with an image sensor (1110) using a flip chip process. Furthermore, the PCB (1100) may be mounted with component part (113). The component part (113) may be a controller for image data process of the image sensor (1110), or active and passive elements for noise removal. The image sensor (1110) includes an effective image area (1111) as illustrated in FIG. 4.

The effective image area (1111) may be provided in a rectangular shape as illustrated in FIG. 4. The effective image area (1111) is formed by a first side (1111a) and a second side (1111b), where the second side (1111b) is longer than the first side (1111a). A length ratio of the first and second sides (1111a, 1111b) may be variably provided and the length ratio of the second side (1111b) and the first side (1111a) may be 16:9 to support the full high definition image. The first side (1111a) may be parallel with the long side (1001) of the PCB (1100) and the second side (1111b) may be parallel with the short side of the PCB (1100).

Referring to FIG. 6, the camera module according to the second exemplary embodiment of the present disclosure may be mounted on the mobile terminal (1), where the mobile terminal (1) may include a display panel (2). The display panel (2) may include a third side (3) and a fourth side (4) longer than the third side (3). At this time, the mobile terminal (1) according to the camera module according to the second exemplary embodiment of the present disclosure may include the first side (1111a) parallel with the third side (3) and the second side (1111b) parallel with the fourth side (4).

The PCB (110) may be a ceramic multi-layer substrate when the image sensor (1110) is mounted on the PCB (1100) using the flip chip process. The flip chip process is an electrically connecting process when an electrode pattern or an inner lead is formed with a lug using a conductive member such as a solder ball and when a chip such as an image sensor (1110) is mounted on the PCB (1100), whereby a space can be saved for connection over a general wire bonding. In case of flip chip bumping, it is generally called an UBM (Under Bump Metallurgy), where, three layers of a junction layer, a diffusion barrier layer and a wettable layer, as a bond-easy multiple metal layer formed between electrodes and bump to prevent diffusion to the chip, may be formed, because it is difficult to directly form a solder or an Au bump on an AL or Cu electrode of semiconductor chip. The flip chip connection process will not be further elaborated because of well-known prior art.

Referring to FIG. 5, the PCB (1100) may include a groove part (1101) at a floor surface. The groove part (1101) may be formed therein with a terminal pattern (1102), and the image sensor (1110) is directly connected to the terminal pattern (1102) of the groove part (1101), or may be conductively mounted using a conductive member. At this time, the conductive member may be a solder bump, a conductive polymer, a conductive film or a conductive paste.

The PCB (1100) may be mounted at an upper surface with an IR (Infrared) cut-off member (1125) as illustrated in FIG. 5. The IR cut-off member (1125) may be provided in the form of a BG (Blue Glass), an IR cut-off filter, an IR reflective filter, and an IR absorption filter.

The BG may solve the discoloring (or fading) problem of intended transparency of visible ray in which a conventional IR cut-off member made of using phosphate becomes warm as a production hall or a pants pocket and surface is eroded or loses gloss when condensation develops in a wet space. The BG is excellent in corrosion-resistance, and can maintain the transparency of the filter glass when an additional coating is performed. Furthermore, the BG can obtain an excellent reproducibility, a predetermined amount of transmittance and a wavelength characteristic through continuous glass melting process.

Meantime, the camera module according to first and second exemplary embodiments of the present disclosure may commonly include a holder member (140) and a lens module (150).

The holder member (140) may be coupled to an upper surface of the PCB (100, 1100) and the lens module (150) may be screw-connected to the holder member (140). However, the present disclosure is not limited thereto, and the lens module (150) may be integrally formed with the holder member (140).

That is, as illustrated in FIGS. 3 and 5, the lens module (150) may be formed at a circumference with a screw thread (151) and formed at an inner side with at least one sheet of lenses (155). A female screw thread (141) formed at an inner surface of the holder member (140) may be screw-connected to the screw thread (151) to adjust a focus between the lens (155) and the image sensor (110, 1110). A camera module formed with an optical system thus configured is called a focusing type camera module.

Although not illustrated, the lens module (150) may be integrally formed with the holder member (140). When the holder member (140) is injection-molded, the holder member (140) may be insert-injected with the lens module (150) being inserted, and a plural sheet of lenses (155) may be directly coupled to an inner side of the holder member (140). The camera module having an optical system thus configured is called a focusing free type camera module.

The lens module (150) may include at least one sheet of lenses (155), where an optical axis of the lens (155) and a center of the effective image area (110a, 1111) may be aligned.

Generally, a center of the image sensor (110, 1110) and a center of the effective image area (110a, 1111) are not precisely aligned. This is because size of the image sensor (110, 1110) may be changed design-wise according to layout due to formation of terminal part and circuit pattern, whereas the effective image area (110a, 1111) must be center-aligned with an optical axis of the lens module (150) in order to allow the camera module to be normally operated.

Referring to FIGS. 3 and 5, a center of the lens module (150) matches a center of the effective image area (110a, 1110) illustrated in FIGS. 1 and 4, and a diameter of the lens module (150) may be determined by the size of the effective image area (110a, 1110). A diameter of an upper surface of the lens module (150) according to the first and second exemplary embodiments of the present disclosure may be formed smaller than a width of the holder member (140) as illustrated, and may be equal to or smaller than a length of short side of the PCB. Alternatively, a length of a short side of a PCB may be determined by a diameter of a lens module.

Although the lens module (150) may be so formed as to have a fixed focus relative to the image sensor (110, 1110), the present disclosure is not limited thereto, and albeit not being illustrated, the present disclosure may further include an actuator configured to perform an auto-focusing function relative to the image sensor (110, 1110). The holder member (140) may be fixed to the PCB (100, 1100) using an adhesive member. The adhesive member may be provided in any one of a thermosetting epoxy and an UV curing epoxy. When the camera module according to first and second exemplary embodiments of the present disclosure is used as a front camera of a mobile terminal, an image photographed from the effective image area (110a) can be outputted to the display panel (2) of the mobile terminal (1) with a fully loaded state.

Mobile terminals are recently formed with a short length and with a long width, a ratio of length of a long side and a short side is 16:9 in order to support a full definition screen viewing. The mobile terminal (1) is used for video telephone (call) in an erect state as shown in FIG. 6, and when a camera module according to the first exemplary embodiment of the present disclosure is applied, a screen photographed through the camera module can be outputted to the display panel (2) with a fully loaded state.

Conversely, when a background method is applied which is different from the exemplary embodiment of the present disclosure, only a crosswise screen is outputted to a display panel of a longer lengthwise direction, whereby upper/lower display screens are shown with a blank to disable using a whole size of the display panel. This is because the first side (111) of the effective image area (110a) is parallel with the third side (3) which is a short side of the display panel mounted on the mobile terminal (1), and the second side (112) is parallel with the fourth side (4), such that an image is not outputted in a state of black letter box being cut out without post-process such as rotation of the photographed image.

When the camera module according the present disclosure is arranged at a front upper section of the mobile terminal having a longer width, a thickness of an upper end bezel is determined by a short side (102) of the PCB (100) of the present disclosure to thereby reduce the thickness of bezel compared with what is determined by long side (101).

When a wire-bondable pad is formed on a short side of the rectangular image sensor according to a third exemplary embodiment of the present disclosure, it should be apparent that the exemplary embodiments of the present disclosure can be realized without CSP or flip chip process as in the first and second exemplary embodiments of the present disclosure.

Because the PCB (100, 1100) is formed in the shape of a rectangular shape, a short side (102, 1002) may be formed with a size corresponding to a bezel of a space between a border of the mobile terminal (1) and the display panel (2). A camera module having a high definition image sensor can be applied to a mobile terminal (1) with a slim bezel method.

Exemplary aspects of the present disclosure are to substantially solve at least the above problems and/or disadvantages and to provide at least the advantages of a camera module, the camera module so miniaturized as to reduce a size of a bezel on a mobile terminal and improved in arrangement structure of image sensor to enable a video call with a full high definition screen.

Accordingly, in one general aspect of the present disclosure, there is provided a camera module, the camera module comprising: a rectangular image sensor including an effective image area; and a rectangular PCB (Printed Circuit Board) mounted with the image sensor, wherein the effective image area includes a first side and a second side formed longer than the first side, and wherein the first side is parallel with a long side of the PCB, and the second side is parallel with a short side of the PCB.

The camera module may be formed on a mobile terminal having a display panel formed with a third side and a fourth side longer than the third side, wherein the first side and the third side of the display panel are parallel, and the second side and the fourth side of the display panel are parallel.

The image sensor may be mounted on the PCB using any one of a CSP (Chip Scale Package) process and a flip chip process.

The first side may be parallel with a short side of the mobile terminal, and the second side may be parallel with a long side of the mobile terminal.

The PCB may be a R-FPCB (Rigid-Flexible Printed Circuit Board).

The camera module may further comprise a glass member arranged above the PCB and the image sensor, wherein a first member of the glass member is conductively connected to the image sensor, and a second member of the glass member is connected to the PCB.

The glass member may include an IR (Infrared) cut-off layer.

The second member may be a solder ball or a gold bead arranged at a space between the second side and a short side of the PCB.

The PCB may be a ceramic multi-layer substrate according to a second exemplary embodiment of the present disclosure.

The PCB may include a groove part at a floor surface, and the image sensor may be directly and conductively mounted in the groove part.

At this time, the PCB may be mounted at an upper surface with an IR (Infrared) cut-off layer.

The camera module may further comprise according to first and second exemplary embodiments of the present disclosure: a holder member coupled to the PCB; and a lens module coupled to the holder member.

The lens module may be screw-connected to the holder member.

The lens module may include at least one sheet of lenses, and an optical axis of the lens and a center of the effective image area may be aligned.

The lens module may be formed with a fixed focus relative to the image sensor.

The lens module may further include an actuator configured to perform an auto focusing function relative to the image sensor.

The PCB and the holder member may be fixedly coupled by an adhesive member.

The adhesive member may be one of a thermosetting epoxy and a UV (Ultraviolet) curing epoxy.

A center of the image sensor and a center of the effective image area may be differently aligned.

The PCB may be mounted with a passive element and an active element.

Teachings in accordance with the exemplary embodiments of the present disclosure have an advantageous effect in that a high-pixel image sensor is connected to a PCB using a CSP (Chip Scale Package) instead of a conventional COB (Chip On Board) process to thereby save as much wiring area as that required by a conventional wire bonding, whereby size of a PCB can be minimized to allow mounting a camera module on a front surface of a mobile terminal having a small-sized bezel.

Another advantageous effect is that, even if a wire bonding pad of a rectangular image sensor is formed at a short side, an effective image area of the image sensor can be arranged to a direction same as that of a display panel of a mobile terminal to thereby reduce a side length of a PCB corresponding to a longer side of the image sensor, whereby there is no need to dispose of a blank at upper and lower sections of the display panel of the mobile terminal during image call. Thus, a high definition image photographed by the camera module can be fully displayed on the display panel.

Accordingly, the meaning of specific terms or words used in the specification and claims should not be limited to the literal or commonly employed sense, but should be construed or may be different in accordance with the intention of a user or an operator and customary usages. Therefore, the definition of the specific terms or words should be based on the contents across the specification, and the same reference numerals are used throughout the different drawings to designate the same components.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A camera module comprising:
a rectangular image sensor including an effective image area; and
a rectangular PCB (Printed Circuit Board) mounted with the image sensor, wherein the effective image area includes a first side and a second side formed longer than the first side, and wherein the first side is parallel with a long side of the PCB, and the second side is parallel with a short side of the PCB.

2. The camera module of claim 1, wherein the camera module is formed on a mobile terminal having a display panel formed with a third side and a fourth side longer than the third side, wherein the first side and the third side of the display panel are parallel, and the second side and the fourth side of the display panel are parallel.

3. The camera module of claim 1, wherein the image sensor is mounted on the PCB using any one of a CSP (Chip Scale Package) process and a flip chip process.

4. The camera module of claim 3, wherein the first side is parallel with a short side of the mobile terminal, and the second side is parallel with the long side of the mobile terminal.

5. The camera module of claim 1, wherein the PCB is an R-FPCB (Rigid-Flexible Printed Circuit Board).

6. The camera module of claim 1, further comprising a glass member arranged above the PCB and the image sensor, wherein a first member of the glass member is conductively connected to the image sensor, and a second member of the glass member is connected to the PCB.

7. The camera module of claim 6, wherein the glass member includes an IR (Infrared) cut-off layer.

8. The camera module of claim 6, wherein the first and second members are solder balls arranged at a space between the second side and a short side of the PCB.

9. The camera module of claim 1, wherein the PCB is a ceramic multi-layer substrate.

10. The camera module of claim 9, wherein the PCB includes a groove part at a floor surface, and the image sensor is directly and conductively mounted in the groove part.

11. The camera module of claim 9, wherein the PCB is mounted at an upper surface with an IR (Infrared) cut-off layer.

12. The camera module of claim 1, further comprising:
a holder member coupled to the PCB; and
a lens module coupled to the holder member.

13. The camera module of claim 12, wherein the lens module is screw-connected to the holder member.

14. The camera module of claim 12, wherein the lens module includes at least one sheet of lens, and an optical axis of the lens and a center of the effective image area are aligned.

15. The camera module of claim 12, wherein the lens module is formed with a fixed focus relative to the image sensor.

16. The camera module of claim 12, wherein the lens module further includes an actuator configured to perform an auto focusing function relative to the image sensor.

17. The camera module of claim 12, wherein the PCB and the holder member are fixedly coupled by an adhesive member.

18. The camera module of claim 17, wherein the adhesive member is one of a thermosetting epoxy and a UV (Ultraviolet) curing epoxy.

19. The camera module of claim 1, wherein a center of the image sensor and a center of the effective image area are differently aligned.

20. The camera module of claim 1, wherein the PCB is mounted with a passive element and an active element.
